(19) United States
(12) Patent Application Publication
(10) Pub. No.: US 2022/0021036 A1
(43) Pub. Date: Jan. 20, 2022

(54) SYSTEMS, METHODS, AND DEVICES FOR INCREASED CHARGING SPEED OF LITHIUM-BASED BATTERY PACKS

(71) Applicant: MILWAUKEE ELECTRIC TOOL CORPORATION, Brookfield, WI (US)

(72) Inventors: Samuel Sheeks, Germantown, WI (US); William Darius Varian, Menomonee Falls, WI (US)

(21) Appl. No.: 17/379,717

(22) Filed: Jul. 19, 2021

Related U.S. Application Data
(60) Provisional application No. 63/053,818, filed on Jul. 20, 2020.

(51) Int. Cl. H01M 10/44; H01M 10/0525; H02J 7/00

(52) U.S. Cl. CPC H01M 10/443; H01M 10/0525; H01M 2220/30; H02J 7/007194; H02J 7/007182

(57) ABSTRACT

Battery pack chargers described herein for charging a battery pack include a battery pack receiving portion, a power control module, and a controller. The battery pack receiving portion receives and interfaces with the battery pack. The battery pack includes one or more battery cells. The power control module is configured to provide power to the battery pack receiving portion. The controller is connected to the power control module. The controller is configured to provide a charging current to one or more battery cells of the battery pack using a stepped charging profile. The step charging profile includes a first charging current level. The first charging current level is greater than a predetermined maximum charging current for the battery pack. The controller steps down the charging current to a second charging current level when a voltage of the one or more battery cells increases to a predetermined voltage value.

### RELATED APPLICATIONS

This application claims the benefit of U.S. Provisional Patent Application No. 63/053,818, filed Jul. 20, 2020, for all subject matter common to both applications. The disclosure of said provisional application is hereby incorporated by reference in its entirety.

### FIELD

Embodiments described herein provide a battery pack charger.

### SUMMARY

Battery pack chargers described herein increase the speed with which battery packs including lithium-based battery cells can be charged (i.e., reduce charging time) when compared to existing charging techniques (e.g., constant-current constant voltage [“CC/CV”] charging).

Methods described herein for charging a battery pack include connecting the battery pack to a battery pack charger, providing a charging current to one or more battery cells of the battery pack using a stepped charging profile, the step charging profile including a first charging current level, the first charging current level being greater than a predetermined maximum charging current for the battery pack, and stepping down the charging current to a second charging current level when a voltage of the one or more battery cells increases to a predetermined voltage value.

Methods described herein for charging a battery pack include connecting the battery pack to a battery pack charger, providing a charging current to one or more lithium-ion battery cells of the battery pack using an over-voltage charging profile, the over-voltage charging profile including a first charging current level, the first charging current level being greater than a predetermined maximum charging current for the battery pack, charging the one or more lithium-ion battery cells to a voltage exceeding a predetermined maximum charging voltage limit for the one or more lithium-ion battery cells, and stopping the charging current after the voltage exceeds the predetermined maximum charging voltage limit.

Battery pack chargers described herein for charging a battery pack include one or more battery pack receiving portions, a power control module, and a controller. The one or more battery pack receiving portions receive and interface with the battery pack. The battery pack includes one or more battery cells. The power control module is configured to provide power to the one or more battery pack receiving portions. The controller is connected to the power control module. The controller is configured to provide a charging current to one or more battery cells of the battery pack using a stepped charging profile. The step charging profile includes a first charging current level. The first charging current level is greater than a predetermined maximum charging current for the battery pack. The controller is also configured to step down the charging current to a second charging current level when a voltage of the one or more battery cells increases to a predetermined voltage value.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Other aspects of the embodiments will become apparent by consideration of the detailed description and accompanying drawings.

### BRIEF DESCRIPTION OF THE DRAWINGS

FIG. 1A is a perspective view of a battery pack charger according to embodiments described herein.

FIG. 1B is a perspective view of a battery pack charger according to embodiments described herein.

FIG. 2 is an electromechanical diagram of a controller for the battery pack charger of FIG. 1 according to embodiments described herein.

FIG. 3 illustrates a constant-current constant-voltage charging profile.

FIG. 4 illustrates a stepped charging profile, according to embodiments described herein.

FIG. 5 illustrates a constant-voltage charging profile, according to embodiments described herein.

FIG. 6 illustrates an over-voltage charging profile, according to embodiments described herein.

FIG. 7 illustrates a dynamic charging profile, according to embodiments described herein.

### DETAILED DESCRIPTION

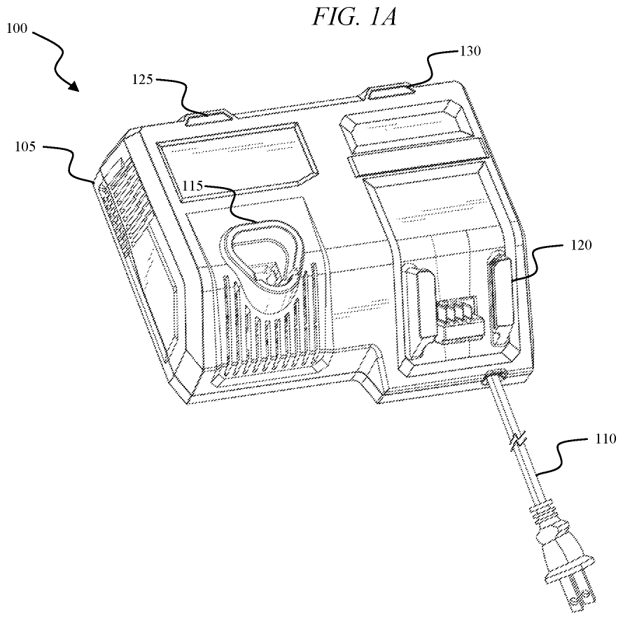

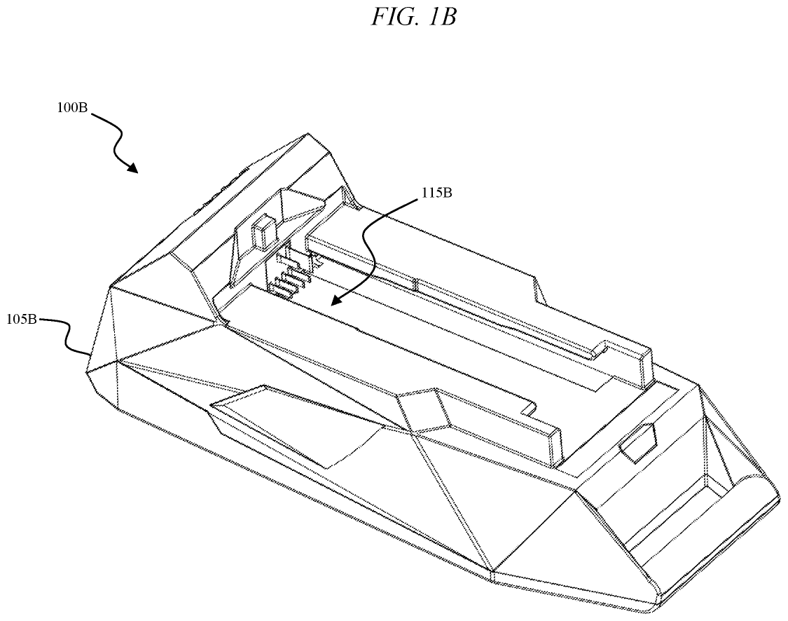

FIG. 1A illustrates a battery pack charger or charger 100. The battery pack charger 100 includes a housing portion 105 and an AC input power plug 110. The battery pack charger 100 can be configured to charge one or more battery packs having one or more nominal voltage values. For example, the battery pack charger 100 illustrated in FIG. 1A is configured to charge a first type of battery pack using a first battery pack receiving portion or interface and a second type of battery pack using a second battery pack receiving portion or interface 120. The first type of battery pack is, for example, a 12V battery pack having a stem that is inserted into the first battery pack receiving portion or interface 115. The second type of battery pack is, for example, an 18V battery pack having a plurality of rails for slidably attaching the battery pack in the second battery pack receiving portion or interface 120. In some embodiments, the battery pack charger 100 can include one or more indicators 125, 130 providing visual feedback to a user as to the charging status of the attached battery packs.

FIG. 1B illustrates a battery pack charger 100B. 1 The battery pack charger 100B includes a housing portion 105. The battery pack charger 100B can be configured to charge battery packs having one or more nominal voltage values. For example, the battery pack charger 100B illustrated in FIG. 1B is configured to charge a battery pack using a battery pack receiving portion or interface 115B. The battery pack is, for example, an 80V battery pack having a plurality of rails for slidably attaching the battery pack in the battery pack receiving portion or interface 115B.

The battery packs can each include a plurality of lithium-based battery cells having a chemistry of, for example, lithium-cobalt (“Li-Co”), lithium-manganese (“Li-Mn”), or Li-Mn spinel. In some embodiments, the battery cells have other suitable lithium or lithium-based chemistries, such as a lithium-based chemistry that includes manganese, etc. The battery cells within each battery pack are operable to provide power (e.g., voltage and current) to one or more power tools. Although the present disclosure is discussed with respect to lithium batteries, any batteries can be used.

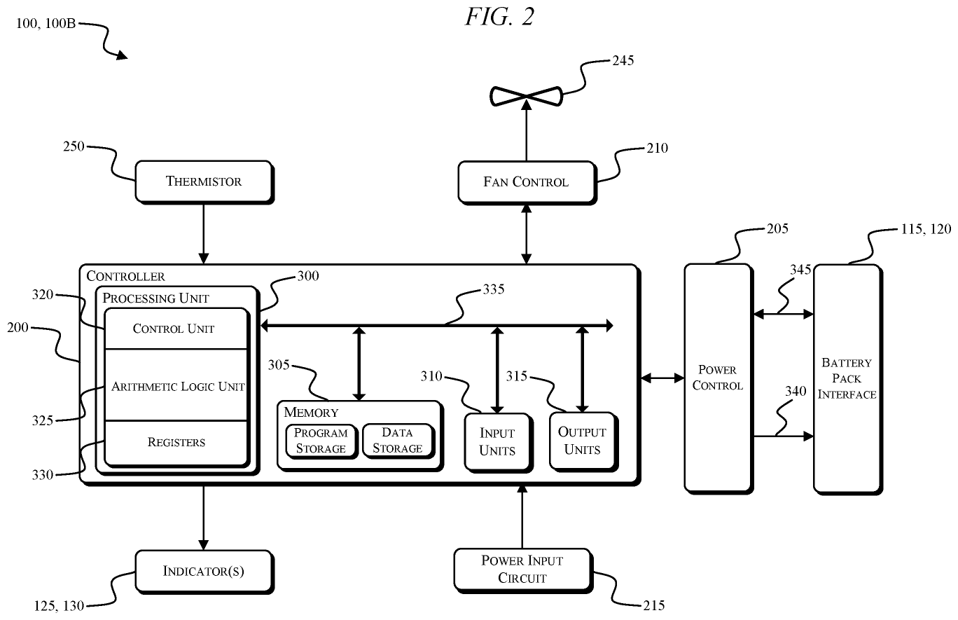

A controller 200 for the battery pack charger 100, 100B is illustrated in FIG. 2. The controller 200 is electrically and/or communicatively connected to a variety of modules or components of the battery pack charger 100, 100B. For example, the illustrated controller 200 is connected to the first and second battery pack portions or interface(s) 115, 120 through a power control module 205. The controller 200 can include or otherwise be in communication with the indicators 125, 130, a fan control module 210, a power input circuit 215, and a thermistor 250. The controller 200 includes combinations of hardware and software that are operable to, among other things, control the operation of the battery pack charger 100, 100B, activate the indicators 125, 130 (e.g., one or more LEDs), estimate the temperature of a first heatsink, measure the temperature of a second heatsink, etc.

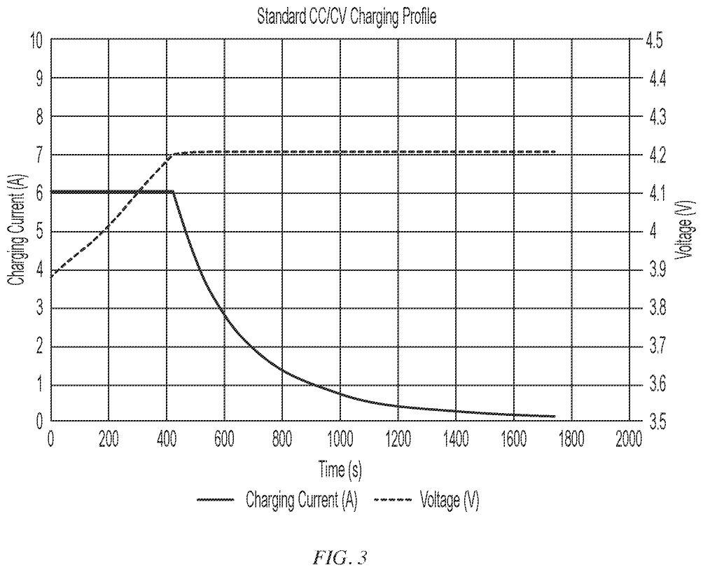

The controller 200 includes a plurality of electrical and electronic components that provide power, operational control, and protection to the components and modules within the controller 200 and/or battery pack charger 100, 100B. For example, the controller 200 includes, among other things, a processing unit 300 (e.g., an electronic processor, a microprocessor, a microcontroller, or another suitable programmable device), a memory 305, input units 310, and output units 315. The processing unit 300 includes, among other things, a control unit 320, an ALU 325, and a plurality of registers 330 (shown as a group of registers in FIG. 2), and is implemented using a known computer architecture (e.g., a modified Harvard architecture, a von Neumann architecture, etc.). The processing unit 300, the memory 305, the input units 310, and the output units 315, as well as the various modules connected to the controller 200 are connected by one or more control and/or data buses (e.g., common bus 335). The control and/or data buses are shown generally in FIG. 3 for illustrative purposes. The use of one or more control and/or data buses for the interconnection between and communication among the various modules and components would be known to a person skilled in the art in view of the invention described herein.

The memory 305 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 300 is connected to the memory 305 and executes software instructions that are capable of being stored in a RAM of the memory 305 (e.g., during execution), a ROM of the memory 305 (e.g., on a generally permanent basis), or another non-transitory computer readable medium such as another memory or a disc. Software included in the implementation of the battery pack charger 100, 100B can be stored in the memory 305 of the controller 200. The software includes, for example, firmware, one or more applications, program data, filters, rules, one or more program modules, and other executable instructions. The controller 200 is configured to retrieve from the memory 305 and execute, among other things, instructions related to the control processes and methods described herein. In other constructions, the controller 200 includes additional, fewer, or different components.

The battery pack interface(s) 115, 120 includes a combination of mechanical components and electrical components configured to and operable for interfacing (e.g., mechanically, electrically, and communicatively connecting) the battery pack charger 100, 100B with a battery pack. For example, the battery pack interface(s) 115, 120 is configured to receive power from the power control module 205 via a power line 340 between the power control module 205 and the battery pack interface(s) 115, 120. The battery pack interface(s) 115, 120 is also configured to communicatively connect to the power control module 205 via a communications line 345.

In some embodiments, the controller 200 measures a temperature associated with the second heatsink using the thermistor 250, which is proportional to the output of the power input circuit 215. Based on the measured temperature of a DC circuit region, the controller 200 estimates a temperature of an AC circuit region and first heatsink. The thermal relationships or gradients between the temperature measured by the thermistor 250 and other components of the battery pack charger 100, 100B can be stored in the memory 305 of the controller 200. As a result, the temperature measured by the thermistor 250 can be used as an observer to estimate the temperature of other components of the battery pack charger 100, 100B. For example, losses from an input section of the power input circuit 215 are generally inversely proportional to the input voltage of the power input circuit 215. Without knowing the actual input voltage to the power input circuit 215, the thermal relationship between the temperature measured by the thermistor 250 and the power input circuit 215 (i.e., the AC circuit region) may be invalid. By determining the input voltage of the power input circuit 215 (i.e., the AC input line voltage to the battery pack charger 100, 100B), the controller 200 can select an appropriate thermal relationship between the temperature measured by the thermistor 250 and the power input circuit 215 for determining the temperature of the AC circuit region and first heatsink.

After determining the temperature of the AC circuit region and the first heatsink, the controller 200 provides information and/or control signals to the fan control module 210 for driving the fan 245. Driving the fan 245 includes turning the fan 245 ON, turning the fan 245 OFF, increasing the rotational speed of the fan 245, decreasing the rotational speed of the fan, etc. The fan 245 is driven to maintain a desirable operating condition for the battery pack charger 100, 100B. In some embodiments, the fan 245 is operated to maintain the temperature (e.g., internal ambient temperature) of the battery pack charger 100, 100B within a desired range of temperatures (e.g., 40° F. to 105° F.). In other embodiments, the fan 245 is operated to maintain the temperature (e.g., internal ambient temperature) of the battery pack charger 100, 100B at a particular temperature (e.g., 85° F.).

FIG. 3 illustrates a constant-current constant voltage (“CC/CV”) charging profile. A constant current is applied according to the battery cell manufacturer's recommendation until any one cell in a battery pack reaches 4.2V. The industry standard maximum voltage allowed on a lithium ion cell is 4.2V. Battery cells connected in a parallel configuration within a battery pack can each be charged at the manufacturer rated current. For example, if a single cell is rated for a 6A charging current, three battery cells connected in parallel can collectively be charged at an 18A charging current. Once one cell voltage reaches 4.2V, the charging voltage is held constant and the current decays until it effectively reaches zero. In other words, a normal CC charge rating (e.g., of 6 Amperes) is applied until any one cell in a battery pack reaches 4.2V, then the battery pack charger 100, 100B switches from CC to CV mode, so the voltage is maintained at 4.2V while current is gradually reduced to 0. When voltage is 4.2, with no current applied, the battery cell or battery pack is then considered to be fully charged. In some embodiments, such a charging technique takes more than 1700 seconds for a conventional lithium battery cell (e.g., the SDI 15M 18650 cell).

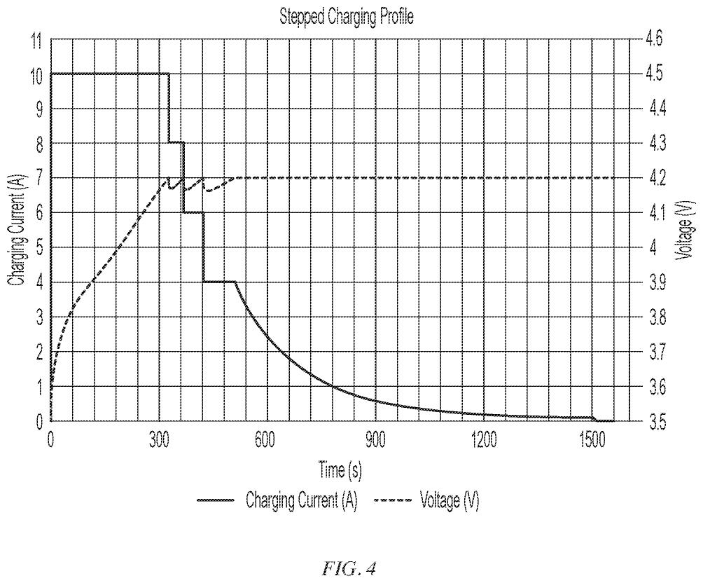

FIG. 4 illustrates a stepped charging profile. Initially, in the stepped charging profile, a fixed constant current is applied with a current value that exceeds the normal charge rating (e.g., 6 Amperes) at the beginning of the charging process so as to charge the battery cells more quickly at a lower state of charge (“SOC”). For example, as shown in FIG. 4, a 10 Amperes charge is applied to battery cells that are normally rated for charging of 6 Amperes. Higher charge rates at low SOC have been determined to not adversely impact cycle life degradation as much as higher charge rates at a high SOC. As voltage in any of the cell(s) in a battery pack increases, the charge current is gradually reduced (e.g., stepped down) as the SOC of the battery cells increases in order to maintain cycle life of the battery cells and to not exceed the 4.2V cell voltage limit recommended by the battery cell manufacturers. For example, as the voltage of a battery cell reaches 4.2V, the charge current is reduced in a predetermined step size, for example, form 10 Amperes to 8 Amperes, to reduce the voltage. This process continues until a constant voltage value is maintained, for example, at 4.2V, while the current is gradually reduced to 0. In some embodiments, such a charging technique decreases charging time from 1700 seconds for CC/CV charging to 1500 or fewer seconds.

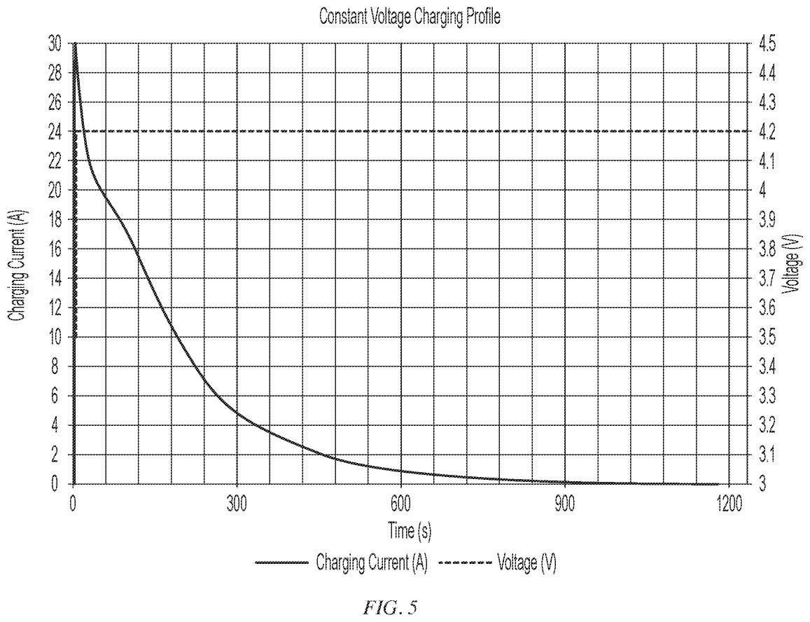

FIG. 5 illustrates a constant voltage (“CV”) charging profile. The CV charging profile eliminates the constant current (“CC”) portion of a CC/CV charging profile. The CV charging profile applies the maximum voltage allowed by the battery cell manufacturers (e.g., 4.2V), which charges the cell without exceeding the cell manufacturer's maximum voltage limit. Therefore, from initialization of the profile, the charging voltage is held constant and the current decays from an initial value (e.g., about 30 Amperes) until it effectively reaches zero. The battery cell or battery pack is then considered to be fully charged. In some embodiments, such a charging technique decreases charging time from 1700 seconds for CC/CV charging to 1200 or fewer seconds.

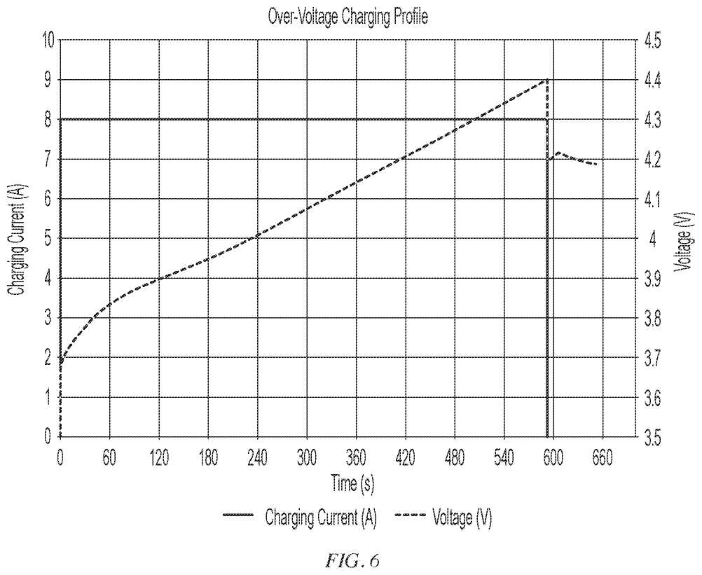

FIG. 6 illustrates an over-voltage charging profile. The over-voltage charging profile permits the supply voltage to the battery pack or battery cell to exceed the normal cell manufacturer's maximum voltage limit (e.g., 4.2V) while using the charging current and cell resistance to ensure that the voltage of a battery cell does not significantly exceed the normal cell manufacturer's maximum voltage limit. The over-voltage charging profile may also exceed the normal charge rating (e.g., 6 Amperes) during charging. The over-voltage charging profile allows the battery charger to remain in a CC charging mode for a longer time. For example, the charging profile can have an initial constant current of about 8 Amperes while the voltage can increase to and exceed the voltage limit of 4.2V up to about at least 4.4V, at which point the charging current will stop. After exceeding the normal cell manufacturer's maximum voltage limit, the battery cell voltage returns to the normal cell manufacturer's maximum voltage limit after the charging current is stopped. In some embodiments, such a charging technique decreases charging time from 1700 seconds for CC/CV charging to 600 or fewer seconds.

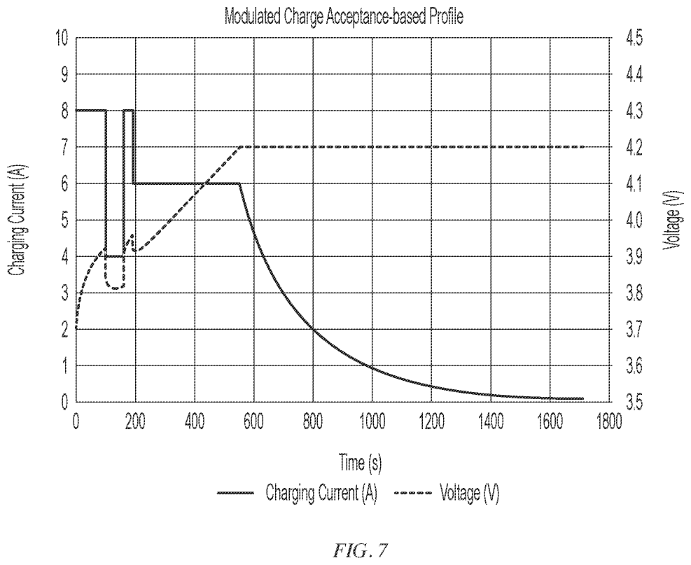

FIG. 7 illustrates a dynamic or charge-acceptance based charging profile. The dynamic charging profile includes adjusting both the current and voltage throughout the charge cycle to ensure optimum speed and cycle life using parameters such as SOC, temperature, cell age, cell health, and charge acceptance based differential voltage. The dynamic charging profile allows for increased charge rate and mitigates some of the adverse consequences to battery cell cycle life that result from increased charging speed. The dynamic charging profile exceeds the normal charge rating (e.g., 6 Amperes) during portions of the charging. As depicted in FIG. 7, for example, the initial charge rate can be 8 Amperes (which is above a normal predetermined charge rating of 6 Amperes). As the voltage of the battery cells approaches 4V, the charge current can step down to about 3 Amperes for a predetermined period of time before stepping back up to 8 Amperes. Thereafter, the charge current can step down again to the normal charge rating of 6 Amperes until the battery cells reach the limit of 4.2V and then the current can decay to about zero. In some embodiments, such a charging technique can have a charging time of 1700 or fewer seconds while mitigating some adverse consequences to battery cell cycle life that result from increased charging speed.

In operation, the battery pack charger 100, 100B can be provided to charge one or more battery packs connected to the battery pack interface(s) 115, 120. Initially, a user can insert at least one battery pack into a battery pack charger, for example, sliding the battery pack(s) into one or the battery pack interface(s) 115, 120. Thereafter, the battery pack charger 100, 100B can charge the at least one battery pack via the battery pack interface(s) 115, 120. For example, the battery pack charger 100, 100B can provide power (e.g., via a power line 340) to the at least one battery pack through the power control module 205 to the battery pack interface(s) 115, 120. In some embodiments, the battery pack charger 100, 100B can communicate with the at least one battery pack (e.g., via communications line 345) to control a rate in which the at least one battery pack receives the power based on a combination of a charging profile and other parameters (e.g., SOC, temperature, cell age, cell health, and charge acceptance based differential voltage). The charging profiles and other paraments can be both monitored data with the battery pack and/or data stored in the memory 305 of the battery pack charger 100, 100B.

In some embodiments, the battery pack charger 100, 100B (via controller 200) can be implemented to execute each of the charging profiles discussed with respect to FIGS. 3-7. The battery pack charger 100, 100B can be pre-programmed with one or more of the charging profiles, for example, stored in memory 305 to be executed by processing unit 300. The battery pack charger 100, 100B can be specifically designed to execute one or more of the charging profiles or it can be designed to change between charging profiles. For example, the battery pack charger 100, 100B can include a selector for choosing which battery profile to execute or it can select a charging profiled based on any combination of battery size, type, environmental conditions, etc. Multiple simultaneously connected battery packs can be charged using the same charging profile or they can be charged using different charging profiles. For example, a 12V battery pack having a stem can be charged using one charging profile while an 18V battery pack having a plurality of rails can be charged using another charging profile. In some embodiments, the controller 200 can monitor the charging of the connected battery packs, for example, through any combination of the battery pack interface(s) 115, 120, power control module 205, power input circuit 215, thermistor, power input circuit 215, input units 310, output units 315, etc. The controller 200 can process (e.g., processing unit 300) the monitored data and update the charging (e.g., current and/voltage) based on a combination of the charging profiles and the monitored data.

Thus, embodiments described herein provide, among other things, a battery charger with improved charging speed for battery packs including lithium-based battery cells.

What is claimed is:

1. A method for charging a battery pack, the method comprising:
connecting the battery pack to a battery pack charger;
providing a charging current to one or more battery cells of the battery pack using a stepped charging profile, the step charging profile including a first charging current level, the first charging current level being greater than a predetermined maximum charging current for the battery pack;
stepping down the charging current to a second charging current level when a voltage of the one or more battery cells increases to a predetermined voltage value.

2. The method of claim 1, wherein the second charging current level is greater than the predetermined maximum charging current.

3. The method of claim 2, further comprising:
stepping down the charging current to a third charging current level,
wherein the third charging current level is less than the predetermined maximum charging current.

4. The method of claim 3, wherein a charging time of the one or more battery cells is less than 1500 seconds.

5. The method of claim 3, wherein the predetermined maximum charging current is at least 6 Amperes.

6. The method of claim 1, wherein the second charging current level is less than the predetermined maximum charging current.

7. The method of claim 1, further comprising:
stepping up the charging current to a third charging current level,
wherein the third charging current level is greater than the predetermined maximum charging current.

8. The method of claim 7, wherein the stepping up the charging current to the third charging current level is based on a parameter of the battery pack.

9. The method of claim 8, wherein the parameter includes at least one of a state-of-charge, a temperature, a cell age, a cell health, and a charge acceptance based differential voltage.

10. The method of claim 8, wherein a charging time of the one or more battery cells is less than 1700.

11. A method for charging a battery pack, the method comprising:
connecting the battery pack to a battery pack charger;
providing a charging current to one or more lithium-ion battery cells of the battery pack using an over-voltage charging profile, the over-voltage charging profile including a first charging current level, the first charging current level being greater than a predetermined maximum charging current for the battery pack;
charging the one or more lithium-ion battery cells to a voltage exceeding a predetermined maximum charging voltage limit for the one or more lithium-ion battery cells; and
stopping the charging current after the voltage exceeds the predetermined maximum charging voltage limit.

12. The method of claim 11, wherein:
the predetermined maximum charging voltage limit is 4.2 volts; and
the voltage exceeding the predetermined maximum charging voltage limit is at least 4.4 volts.

13. The method of claim 11, wherein the predetermined maximum charging current is at least 6 Amperes.

14. The method of claim 11, wherein a charging time of the one or more battery cells is less than 600 seconds.

15. A battery pack charger for charging a battery pack, the battery pack charger comprising:
one or more battery pack receiving portions for receiving and interfacing with the battery pack, the battery pack including one or more battery cells;
a power control module configured to provide power to the one or more battery pack receiving portions; and
a controller connected to the power control module, the controller configured to:
provide a charging current to one or more battery cells of the battery pack using a stepped charging profile, the step charging profile including a first charging current level, the first charging current level being greater than a predetermined maximum charging current for the battery pack, and
step down the charging current to a second charging current level when a voltage of the one or more battery cells increases to a predetermined voltage value.

16. The battery pack charger of claim 15, wherein the second charging current level is greater than the predetermined maximum charging current.

17. The battery pack charger of claim 16, wherein the controller is further configured to:
step down the charging current to a third charging current level,
wherein the third charging current level is less than the predetermined maximum charging current.

18. The battery pack charger of claim 15, wherein the second charging current level is less than the predetermined maximum charging current.

19. The battery pack charger of claim 15, wherein the controller is further configured to:
step up the charging current to a third charging current level,
wherein the third charging current level is greater than the predetermined maximum charging current.

20. The battery pack charger of claim 19, wherein:
the step up of the charging current to the third charging current level is based on a parameter of the battery pack; and
the parameter includes at least one of a state-of-charge, a temperature, a cell age, a cell health, and a charge acceptance based differential voltage.
